(19) United States
(12) Patent Application Publication
(10) Pub. No.: US 2003/0179830 A1
(43) Pub. Date: Sep. 25, 2003

(54) Efficient, high fidelity transmission of modulation schemes through power-constrained remote relay stations by local transmit predistortion and local receiver feedback

(76) Inventors: Donald B. Eidson, San Diego, CA (US); Itzhak Gurantz, San Diego, CA (US); Mats K. Lindstrom, San Diego, CA (US)

Correspondence Address: Robert C. Laurenson, Howrey Simon Arnold & White LLP, 301 Ravenswood Avenue, Box 34, Menlo Park, CA, 94025, US

(21) Appl. No.: 10/108,054

(22) Filed: Mar. 25, 2002

(51) Int. Cl. H04K 1/02

(52) U.S. Cl. 375/296; 375/298

(57) ABSTRACT

A system for pre-distorting samples derived from modulated data symbols to compensate, at least in part, for non-linear operation of a power amplifier in a power-constrained remote relay station. A symbol mapper maps successive renderings of an input alphabet into successive modulation symbols such as but not limited to 16-QAM or 64-QAM symbols. Pre-distortion logic pre-distorts samples derived from the symbols, and logic incorporates samples derived from the pre-distorted samples into a transmission signal. The transmission signal is amplified and transmitted over a communications link to the remote relay station. The system may employ a feedback loop to measure the amount of residual distortion still present is a signal relayed from the relay station and derived from the transmission signal. Responsive to this measured residual distortion, the system dynamically adjusts the amount of pre-distortion (at various input levels) which should be applied to its input samples, to drive the distortion to near-zero or zero, given enough adaptation time.

### BACKGROUND OF THE INVENTION

1. Field of the Invention

This invention generally relates to wireless communications links, and, more specifically, to increasing the capacity of wireless relayed communications links by enabling power-constrained relays to employ modulation schemes such as M-QAM.

2. Related Art

In wireless communication systems, efficient power conversion and power backoff minimization are often important design criteria. In a mobile wireless communications device, for example, it is usually considered important to conserve the amount of battery (DC) power used to generate a certain average RF power output, in order to increase the “talk-time” of the device. In other words, one is attempting to improve the DC-to-RF power conversion efficiency of the device. Similarly, on an onboard satellite transmitter, both peak and output power are constrained due to the limited availability of energy resources (solar cells, etc.). Therefore, minimizing the power backoff of a satellite transmitter (while yet maintaining transmitted signal fidelity) allows the satellite transmitter to deliver the most average power (and consequently, SNR) to a ground-based receiver while consuming the minimum amount of excess transmit power aboard the satellite.

In wireless transmitters, one approach for efficient power amplification is to operate the power amplifier of the transmitter so that its AC voltage swings into a portion of the saturation region. Both this and a linear mode of operation are illustrated in FIG. 1a. Operating point 1 and its associated load line swing 3 lie completely within the linear region 6; however part of the load line swing 7 associated with operating point 2 extends into the saturation region 5 of the power amplifier. (The dashed line in FIG. 1a discriminates between the saturation region 5 and the forward active (linear) region 6 of the power amplifier.) The quiescent power consumed by the device, V_{CE1}×I_{C1}, is less the closer the operating point lies to the the saturation region.

On the other hand, a drawback of operating the power amplifier at or near the saturation region is the introduction of non-linear distortion products into the output signal for input signals beyond a certain magnitude. These distortion products are caused by incursions of the output signal into the saturation region. This effect can be explained with reference to FIG. 1a, which illustrates the swing 7 of the output signal along its load line. As can be seen, because of the placement of the operating point 2 close to the saturation region 5, non-linear distortion products will be introduced into the output of the power amplifier during negative-going swings. As illustrated in FIG. 1b, these distortion products are observable as clipping of the output signal 15. These distortion products lead to distortion in-band (within the same channel), which reduces the effective signal-to-(noise+distortion) ratio observed at the receiver when it demodulates these signals. What's more, these distortion products also cause spectral spillage of harmonics and intermodulation products into out-of-band (adjacent) channels, which appears as interference in those channels, too. As one can imagine, both the in-band and out-of-band artifacts are not desired, because they corrupt channel quality for all users, by raising the ‘noise and interference floor’.

Because of these non-linearities, most operators of on-satellite transmitters limit themselves to M-ary PSK (M-PSK) modulation schemes. By restricting themselves to M-PSK, satellite operators reduce the peak-to-average power ratio of the signaling format, and thus reduce the amount of power amplifier backoff (from average power) that they must provide in order to support high fidelity transmission of the peaks. Phrased another way, given constraints on the peak power that they can support with high fidelity, satellite operators use M-PSK so that they can maximize the average transmission power—because the increased average transmission power commensurately increases the (average) SNR experienced at ground-based receivers. Moreover, M-PSK signal formats are more immune to phase in-band distortions, if transmitted signals are not transmitted with complete fidelity.

This situation for M-PSK is illustrated in FIG. 2a, which illustrates M-PSK symbols 200a, 200b, 200c all located around a unit circle 202. As can be seen, at the optimal symbol sampling times, the (envelope) magnitude E of a signal representing any one of these symbols, which is related to the value \sqrt{I²+Q²}, is a constant. Since the amplitude for each symbol at these sampling times is a constant, each symbol will be affected equally by any non-linearities introduced through negative incursions into the saturation region of the power amplifier. Consequently, some distortion introduced by the power amplifier (at center-symbol sample instants) can potentially be corrected at the receiver.

However, M-PSK modulation schemes result in limited capacity at a particular signal to noise ratio (SNR), and allow an increase in capacity only at the expense of increasing the required SNR. To see this, consider the QPSK modulation scheme illustrated in FIG. 2b, in which each symbol 204a, 204b, 204c, 204d represents two input bits. An increase in capacity is available by migrating to 8-PSK or 16-PSK, in which each symbol represents, respectively, three and four bits. However, each of these schemes involves the addition of additional symbols around the unit circle, which reduces the minimum distance between signaling constellation points, which implies that the operating SNR of the system must be increased to discriminate among the adjacent constellation points.

Linear modulation schemes, such as M-ary Quadrature Amplitude Modulation (M-QAM), are available which offer the potential for higher capacity at a particular average SNR than is available through M-PSK modulation schemes, since the constellation points may be more efficiently spaced with M-QAM. Unfortunately, however, the peak to average power ratio of M-QAM (and similar) constellations tends to be much higher. Even at the optimal symbol sampling instants, the magnitude of M-QAM is not constant, and symbols on the ‘edge’ of the constellation greatly exceed the average power. The situation is illustrated in FIG. 3a in relation to a 16-QAM modulation scheme, where each symbol 300a, 300b, 300c represents four bits. As can be seen, the magnitude of the constellation values E=\sqrt{I²+Q²}, will vary from symbol to symbol, depending on the constellation entry which was selected for transmission. The same situation is present in the 64-QAM modulation scheme as illustrated in FIG. 3b, where each symbol 302a, 302b, 302c represents six bits. There again, the magnitude of the constellation will vary from symbol to symbol; therefore, the input signal to the power amplifier will vary.

Consequently, the technique discussed earlier of correcting for any phase distortion introduced by the transmit power amplifier at the receiver will not work with linear modulation schemes such as M-QAM. Moreover, other attempts at overcoming the distortion introduced by the power amplifier with linear modulation schemes, such as operating the power amplifier far enough away from saturation that clipping is avoided for all possible symbols, is wasteful of power, because the expended DC bias currents associated with these techniques can be large. This situation is illustrated in FIG. 1c which shows the operating point 9 of the power amplifier situated far from the saturation region 5 and within linear region 6 to avoid clipping of all possible symbols. As can be seen, the power consumption of the power amplifier has increased to V_{CE2}×I_{C2}. Since the power consumption of the power amplifier has increased, the average power output of the transmit power amplifier has been reduced, and the SNR which would seen by a receiver is reduced. This loss in SNR is typically compensated for by decreasing the symbol rate, so that more signal energy may be integrated into each symbol. The end result is that the use of linear modulation schemes such as M-QAM will likely result in no net increase in the capacity of the system; in fact, its usage can, in some cases, reduce the capacity of a peak-power-output-limited system.

### SUMMARY

The invention provides a system for pre-distorting samples derived from modulation symbols, such as but not limited to M-QAM symbols, at a ground station transmitter, to compensate at least in part for distortion introduced by non-linear operation of a power amplifier onboard an in-orbit satellite (or other remote) transmitter relay station. Note that the predistortion is made at one transmitter to compensate for distortion which occurs (primarily) in another transmitter.

A digital baseband signal is input to the transmitter system. A symbol mapper maps successive renderings of an input alphabet into successive modulation symbols. In one example, the symbols are linear modulation symbols, including but not limited to a 2^{p}-QAM symbol such as 16-QAM (p=4) or 64-QAM (p=6).

Pre-distortion logic then predistorts samples derived from the symbols, based on their magnitude, to account for non-linear operation of the remote (e.g., on-board satellite) power amplifier, and also possibly non-linear operation of the ground station. In one implementation example, pre-distorted samples are pre-determined for one or more of the possible (paired I and Q) sample values and stored in a lookup table. When a particular sample pair is received, the pre-distortion logic either retrieves a corresponding pre-distorted sample from the lookup table (or interpolates the corresponding pre-distorted sample pair from other entries in the table) and substitutes it for the sample pair from the mapper.

Samples derived from the pre-distorted samples may then be converted to analog signals, and input to a quadrature modulator, which modulates the pre-distorted samples onto a transmission signal. Alternatively, samples derived from the pre-distorted samples, while in digital form, may be modulated by a digital quadrature modulator up to an intermediate frequency. This intermediate digital signal may then be converted to analog form, and the resulting analog signal upconverted to RF frequencies by an RF upconverter, thereby forming the transmission signal.

In either case, the transmission signal may then form the input signal to a power amplifier, which amplifies the signal and transmits the resulting output signal through an antenna. Any distortion introduced by the power amplifier in the remote station is compensated for, at least in part, by the pre-distortion of the symbols.

This signal is then beamed up to a satellite in orbit, or out to a remote station. This remote station/satellite receives the transmitted signal, typically translates it to a different center frequency, amplifies the frequency-translated signal, and sends it back (earthward), toward its receiver audience. The frequency translation and power amplification processing aboard the remote station/satellite is typically done using analog means, a process which is more susceptible to distortions—especially if these processes are to be performed while consuming minimal excess DC power. Therefore, the pre-distortion done at the earth station/originating transmitter is used to compensate, as much as possible, for the distortions these analog processing steps introduce.

A ground receiver, which could be co-located with the earth station/originating transmitter, receives the signal relayed earthward from the satellite/remote station. Typically, this signal is received at a SNR higher than many of the other receivers that are intended to receive the communication. (The SNR advantage is often attributed to the choice of the transmitter/receiver's central location, which would be in the middle of the satellite's coverage footprint, and is also due to the fact that more expensive equipment can be used at the centralized ground station—such as a larger [higher gain] dish antenna, and lower noise amplification circuitry—than would be used with commercially massed produced receivers.) With the high SNR, received signal samples are less noisy, allowing any distortions thereof to be measured with better accuracy.

The ground station receiver measures these distortions, by comparing the received signals with ideal (perfect) signals. The error in both amplitude and phase (referenced with respect to the ideal phase and amplitude levels) is computed. Control loops are then used to compute amplitude and phase corrections (at the ideal phase and amplitude levels) that will eventually drive these errors to zero, or close to zero. These corrections are then incorporated by modifying the pre-distortion lookup table used by the earth station transmitter. Note that the distortions may be measured during the center of transmitted symbols, or at samples in transition intervals between symbols, or at both locations.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the drawings are not necessarily to scale, emphasis instead being placed upon illustrating the principles of the invention. Moreover, in the figures, like reference numerals designate corresponding parts throughout the different views.

FIG. 1A illustrates operation of a power amplifier near the saturation region.

FIG. 1B illustrates nonlinear amplification of the input signal (clipping of the output signal) in a power amplifier operating near the saturation region.

FIG. 1C illustrates operation of a power amplifier operating far from the saturation region.

FIG. 2A illustrates an M-PSK symbol constellation.

FIG. 2B illustrates a QPSK symbol constellation.

FIG. 3A illustrates a 16-QAM symbol constellation.

FIG. 3B illustrates a 64-QAM symbol constellation.

FIG. 4 illustrates a communication link between a ground station transmitter and a ground station receiver through a remote (e.g., satellite) relay station, with a receiver co-located with the transmitter for measuring distortion introduced by the relay station.

FIGS. 5A and 5B are figures that illustrate, respectively, AM/AM and AM/PM distortion characteristics.

FIGS. 6A and 6B illustrate, respectively, amplitude and phase pre-distortion characteristics.

FIGS. 7A and 7B are block diagrams illustrating, respectively, first and second embodiments of a system for pre-distorting samples derived from linear modulation symbols to account for distortion introduced by a power-constrained remote relay station.

FIGS. 7C and 7D are block diagrams illustrating, respectively, third and fourth embodiments of a system for pre-distorting samples derived from linear modulation symbols to account for distortion introduced by a power-constrained remote relay station, the system including a second feedback system for dynamically updating the amount of pre-distortion which is applied responsive to measured residual distortion of the linear modulation symbols.

FIGS. 8A and 8B are simplified block diagrams illustrating alternative embodiments of pre-distortion logic utilized in the systems of FIGS. 7A-7D.

FIG. 9 is a flowchart of an embodiment of a method for pre-distorting samples derived from linear modulation symbols to account for distortion introduced by a power-constrained remote relay station.

FIG. 10 is a flowchart of an embodiment of a method of utilizing a feedback loop to dynamically update the amount of pre-distortion which is applied as determined responsive to measured residual distortion of the linear modulation symbols.

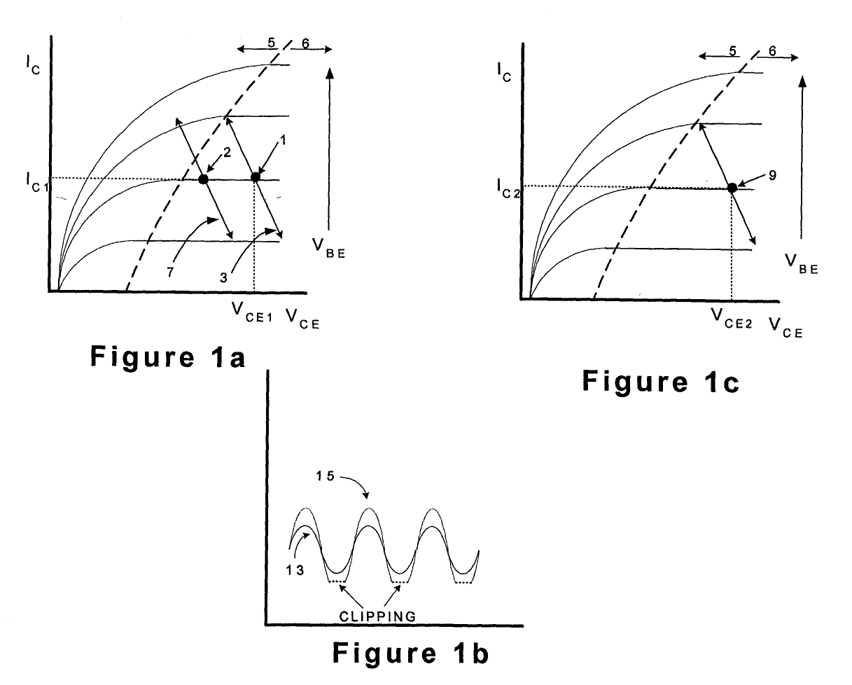

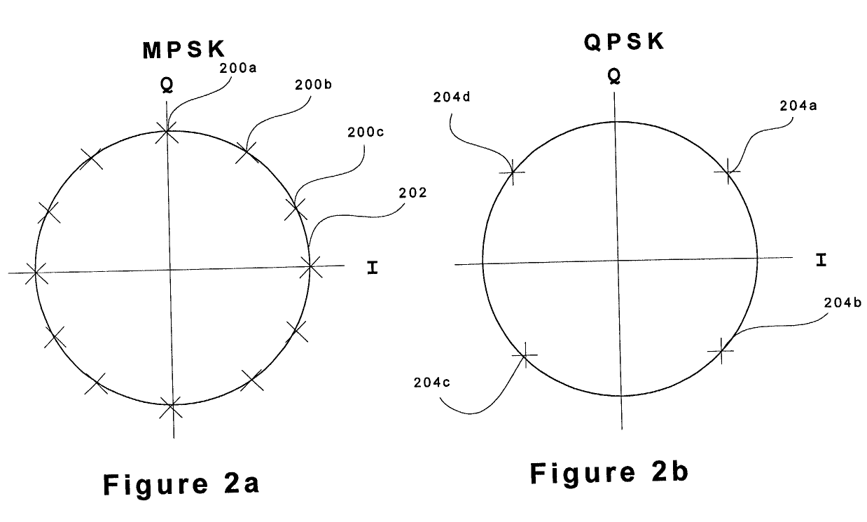

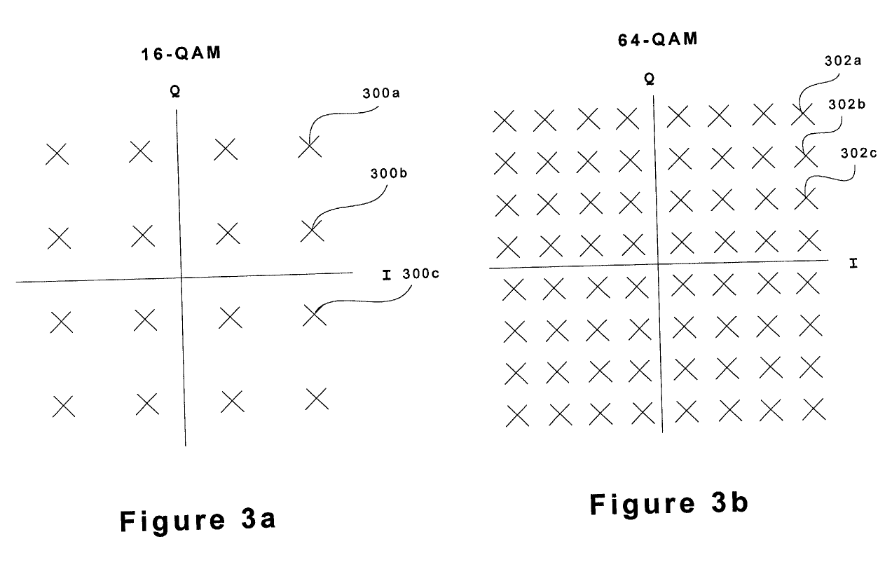

### DETAILED DESCRIPTION

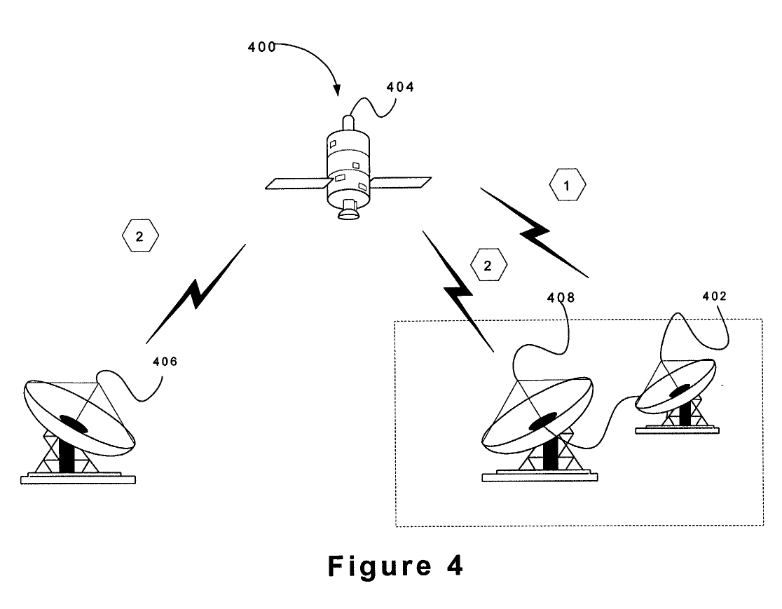

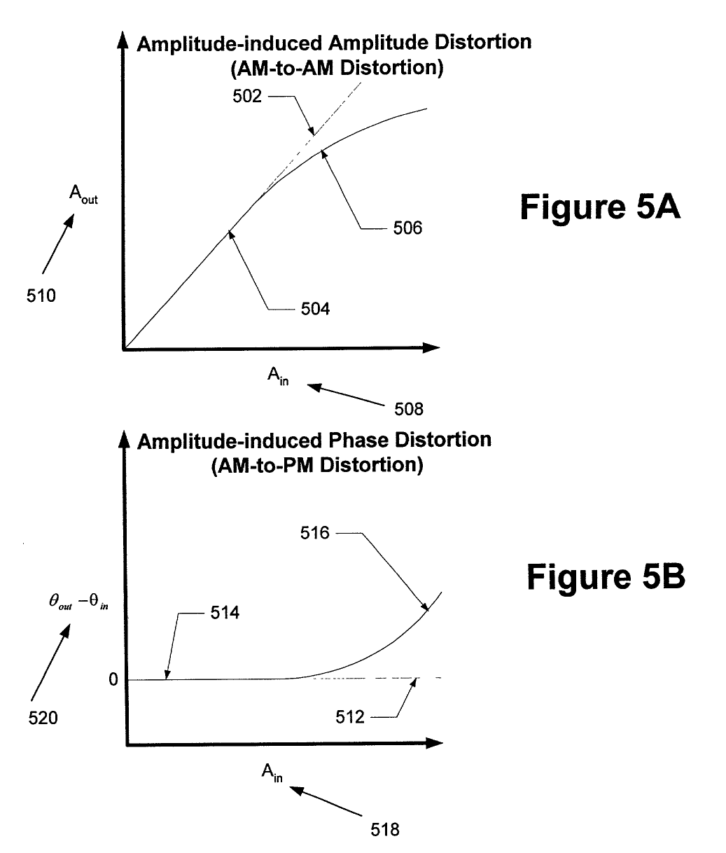

Referring to FIG. 4, a communication system 400 is illustrated in which a communication link is established between a ground transmitter 402 and a remote ground receiver 406 through a relay station 404 that may be but is not limited to a satellite. A receiver 408 may be co-located with the ground transmitter 402. The relay station 404 is power-constrained, and thus introduces distortion into the signal that is relayed from the ground transmitter 402 to the ground receiver 406. Referring to FIG. 5A, the distortion that may be introduced into the amplitude of the signal by relay station 404 is illustrated. Numeral 508 identifies the amplitude of the incoming signal and numeral 510 identifies the amplitude of the outgoing signal. Numeral 502 identifies the ideal characteristic relating the input and output amplitudes assuming no distortion is present, and numerals 504 and 506 identify the actual characteristic that is realized. In particular, numeral 504 identifies the characteristic over the linear region of the power amplifier in the relay station 404, while numeral 506 identifies the characteristic over the saturation region of that power amplifier. As can be seen, in the linear region, the actual characteristic is identical to the ideal characteristic, while in the saturation region, the two deviate quite a bit from one another.

Referring to FIG. 5B, the distortion that may be introduced into the phase of the signal by relay station 404 is illustrated. Numeral 518 identifies the amplitude of the incoming signal and numeral 520 identifies the phase difference between the outgoing and incoming signals. Numeral 512 identifies the ideal characteristic relating the input amplitude and output phase difference assuming no distortion is present, and numerals 514 and 516 identify the actual characteristic that is realized. In particular, numeral 514 identifies the characteristic over the linear region of the power amplifier in the relay station 404, while numeral 516 identifies the characteristic over the saturation region of that power amplifier. As can be seen, in the linear region, the actual characteristic is identical to the ideal characteristic, while in the saturation region, the two deviate quite a bit from one another.

The ground transmitter 402 is configured according to the invention to pre-distort the signal to account for the distortion introduced by the relay station 404. This pre-distortion is achieved by implementing pre-distortion characteristics that counteract at least to some extent the distortion which is introduced.

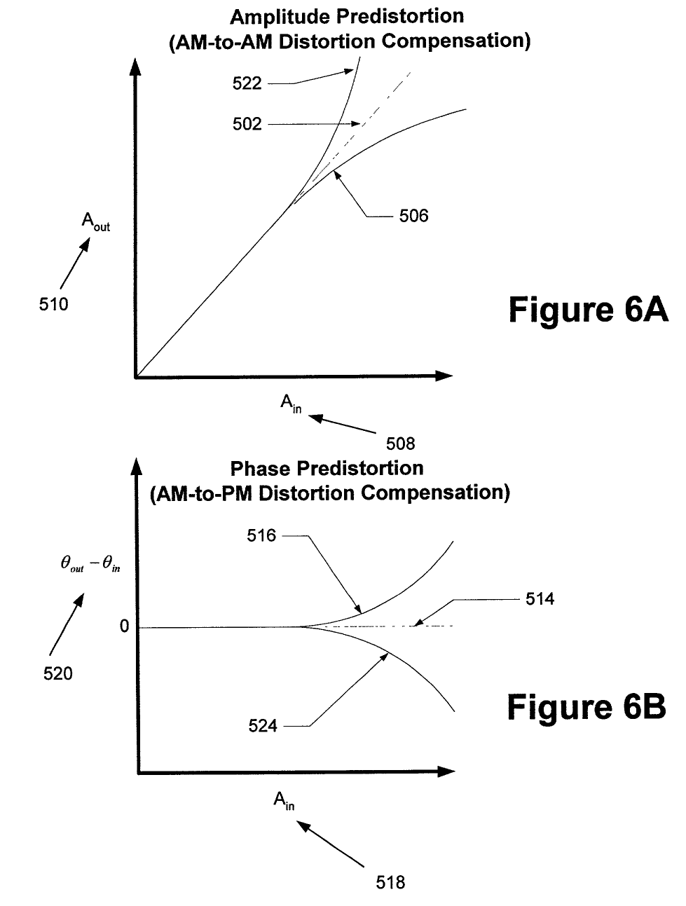

Referring to FIG. 6A, the characteristic defining the pre-distortion function between the incoming and outgoing amplitudes is identified with numeral 522. This characteristic is such that, when combined with the distortion characteristic 506 for the saturation region of operation, the ideal characteristic 502 results.

Referring to FIG. 6B, the characteristic defining the pre-distortion function between the incoming amplitude and phase difference between outgoing and incoming signals is identified with numeral 524. This characteristic is such that, when combined with the distortion characteristic 516 for the saturation region of operation, the ideal characteristic 514 results.

The co-located receiver 408 also receives the signal relayed to ground receiver 406 by relay station 404. After receipt of this signal, receiver 408 measures the extent to which distortion is still present. If residual distortion is present, receiver 408 dynamically modifies the level of pre-distortion applied by ground transmitter 402. This feedback continues until the level of distortion is reduced to an acceptable level or eliminated. This system provides one example application for the subject invention. However, many other examples are possible, so this example should not be taken as limiting.

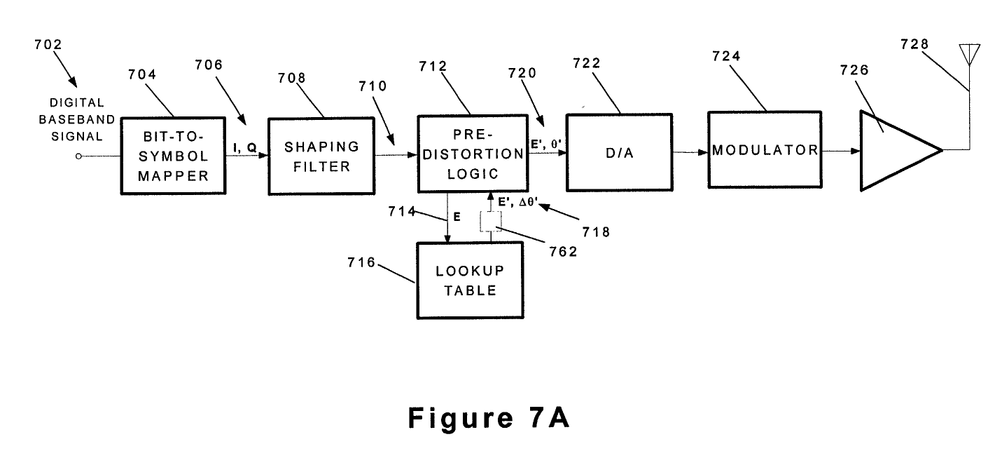

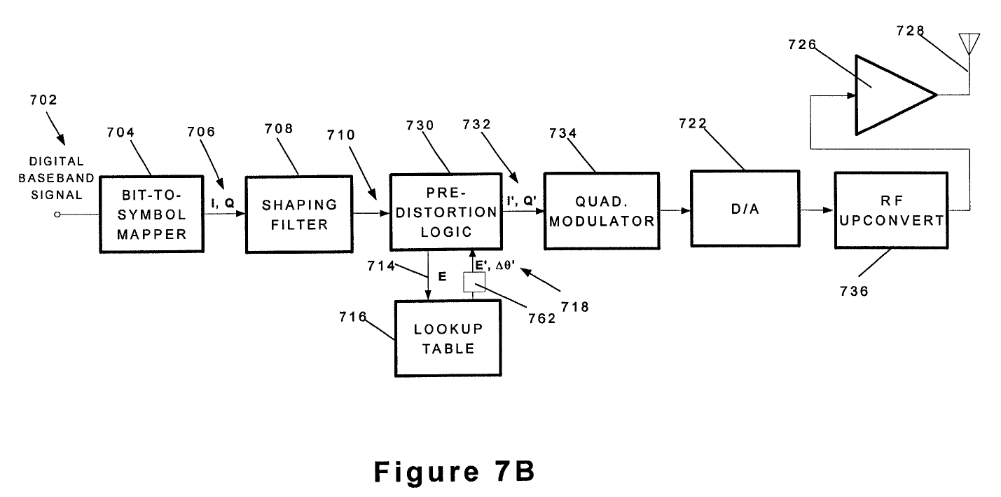

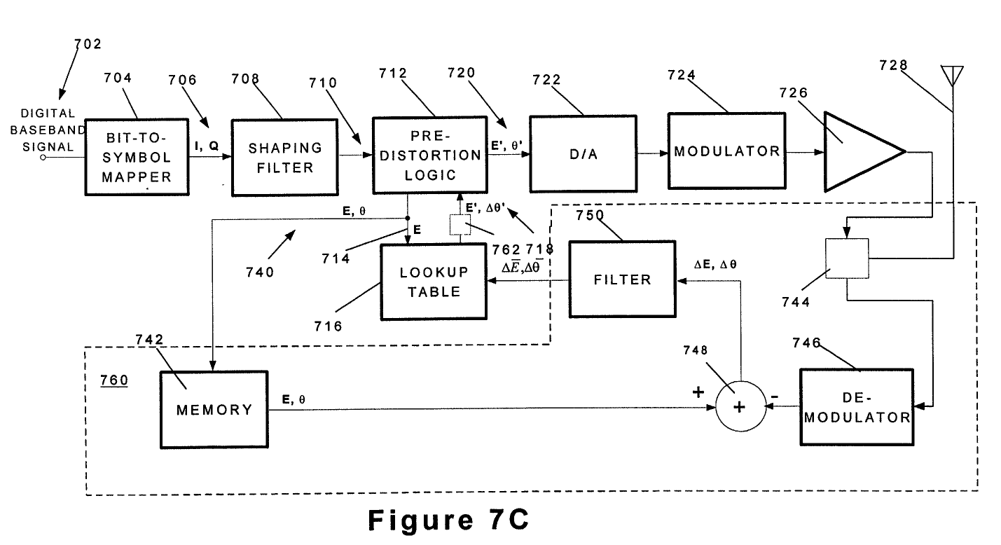

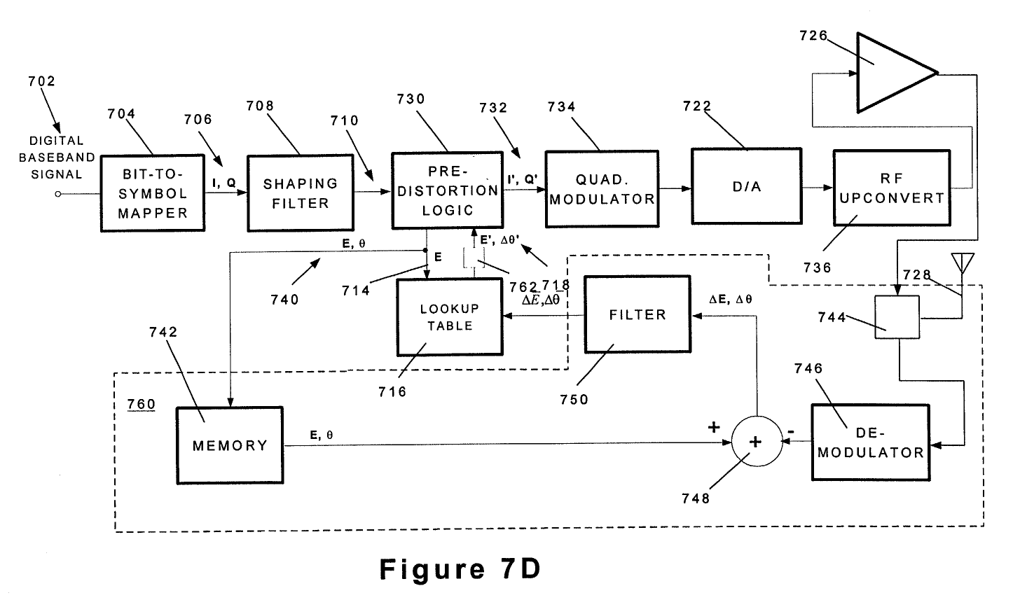

Referring to FIG. 7A, a first embodiment of a system according to the invention for pre-distorting samples derived from modulation symbols to account for distortion introduced by a power-constrained remote relay station is illustrated.

A digital baseband signal 702 is input to symbol mapper 704. Symbol mapper 704 maps each rendering from an input alphabet into a modulation symbol such as a M-QAM symbol. The resultant symbols 706, which are typically in quadrature (I, Q) form, are input to shaping filter 708. Shaping filter 708 is a filter, such as a root-raised cosine filter or a sin(x)/x filter, which interpolates between symbols. The resulting sampling rate should be at least the Nyquist rate, i.e., twice the signal bandwidth, for perfect digital-to-analog conversion to occur. If some of the shaping is to be performed in the digital domain, then the sampling rate may even be higher than this.

The shaped samples 710 are input to pre-distortion logic 712. Pre-distortion logic 712 pre-distorts each of the shaped samples to compensate at least in part for distortion introduced by non-linear operation of the power-constrained remote relay station. To accomplish this, pre-distortion logic 712 translates the samples from rectangular to polar form, i.e., in terms of E and θ. In particular, at samples much finer than the symbol rate, the logic 712 computes the envelope E and phase θ of the signal (either directly or indirectly) from the I and Q (sub-symbol spaced) waveforms. Note that the envelope and phase may be computed from I and Q using E=\sqrt{I²+Q²} and a four-quadrant version of

$$θ = arctan ( \frac{Q}{I} )$$

respectively, and this computation may be performed algebraically, or via lookup table.

Then, it pre-distorts the envelope E and phase θ in accordance with the pre-distortion characteristics 522 and 524 illustrated, respectively, in FIGS. 6A and 6B. Again, this computation may be performed algebraically or via lookup table. In the case where the computation is performed via lookup table, referring to FIG. 7A, an access is made to lookup table 716 using the envelope value E as an index, as identified in the figure with numeral 714. As indicted by identifying numeral 718, the values retrieved through the access either comprise the pre-distorted value E′, and the phase offset Δθ′ corresponding to the value E, or values corresponding to other index values from which E′ and Δθ′ corresponding to the value E may be interpolated. In the case in which interpolation is performed, additional logic, shown in phantom and identified with numeral 762, may need to be included to perform the interpolation function. The value E′ is then substituted for E, and the value θ′ substituted for θ, where θ′=θ+Δθ′. These substituted values are then output from the pre-distortion logic 712, as indicated by identifying numeral 720.

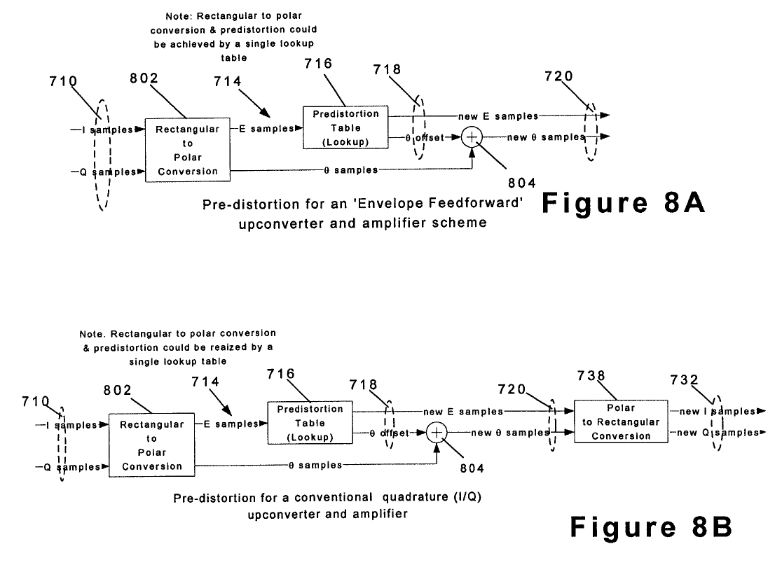

FIG. 8A is a block diagram of one implementation of the pre-distortion logic 712. As illustrated, the shaped samples in rectangular form, identified with numeral 710, are translated to polar form by rectangular to polar translation logic 802. The E component of the translated samples, identified with numeral 714, is used as an index to lookup table 716 to either retrieve pre-distorted values E′ and theta offset values Δθ′ corresponding to E, or other values from which E′ and Δθ′ can be interpolated. These values are collectively identified in the figure with numeral 718. (Alternatively, the translation into polar coordinates and subsequent pre-distortion could be implemented in one look-up table).

The values θ′ are computed by adding (using adder 804) the theta offset values Δθ′ to the incoming phase values θ. Then, the pre-distorted values E′ are substituted for the values E, and the values θ′ are substituted for the values θ. The resulting values E′ and θ′, identified in the figure with numeral 720, are then output from the pre-distortion logic 712.

Referring back to FIG. 7A, the resulting pre-distorted values E′ and θ′ may then be upconverted to RF frequencies and amplified using technology known as “envelope feedforward technology,” which is more fully described in U.S. patent application Ser. No. 09/108,628, filed Jul. 1, 1998; U.S. Pat. No. 6,255,906, issued Jul. 3, 2001; U.S. patent application Ser. No. 09/318,482, filed May 25, 1999; and U.S. patent application Ser. No. 09/481,094, filed Jan. 11, 2000. Each of these patent applications and patents are fully incorporated by reference herein as though set forth in full.

In on example of this technology, such as is illustrated in simplified form in FIG. 7A, the pre-distorted values E′ and θ′ are then converted to analog form by D/A converter 722. The resulting analog values are modulated onto a suitable RF carrier by modulator 724. The modulated carrier is then amplified by power amplifier 726, and the resulting amplified signal transmitted by antenna 728.

Referring to FIG. 7B, a second embodiment of a system according to the invention for pre-distorting samples derived from modulation symbols to account for distortion introduced by a power-constrained remote relay station is illustrated.

This embodiment is identical to the previous embodiment except that pre-distortion logic 730, after determining the pre-distorted values E′ and θ′ as in the previous embodiment, translates the same back into rectangular form, i.e., in the form of pre-distorted quadrature symbols I′ and Q′. The pre-distorted quadrature symbols are then modulated onto an intermediate frequency carrier using quadrature modulator 734. The resulting modulated carrier is then converted to analog form using digital-to-analog converter 722. The resulting signal is then upconverted to RF frequencies using RF upconverter 736. The resulting RF signal is amplified by power amplifier 726, and the amplified signal transmitted using antenna 728.

FIG. 8B is a block diagram of one implementation of the pre-distortion logic 730. As illustrated, the pulse-shaped symbols (i.e., samples) in rectangular form, identified with numeral 710, are translated to polar form by rectangular to polar translation logic 802. The E component of the translated samples, identified with numeral 714, is used as an index to lookup table 716 to either retrieve pre-distorted values E′ and theta offset values Δθ′ corresponding to E or retrieve other values from which E′ and Δθ′ can be interpolated. These values are collectively identified in the figure with numeral 718. (Alternatively, the translation into polar coordinates and subsequent pre-distortion could be implemented in one look-up table).

The values θ′ are computed by adding (using adder 804) the theta offset values Δθ′ to the incoming phase values θ. Then, the pre-distorted values E′ are substituted for the values E, and the values θ′ are substituted for the values θ. The resulting values E′ and θ′, identified in the figure with numeral 720, are then converted to rectangular form by polar to rectangular conversion logic 738. (This logic may also be implemented as a lookup table. In fact, this lookup table could be merged with the lookup tables used for predistortion and/or rectangular-to-polar conversion, so that an I/Q input delivers a pre-distorted I/Q output.) The resulting pre-distorted quadrature samples, identified with numeral 732, are then output from the pre-distortion logic 730.

Referring to FIG. 7C, a third embodiment of a system for pre-distorting samples derived from modulation samples to account for distortion introduced by a power-constrained remote relay station is illustrated. This embodiment is identical to the first embodiment illustrated in FIG. 7A in relation to the manner in which incoming samples are pre-distorted, upconverted to RF frequencies, and then transmitted. However, the embodiment of FIG. 7C builds upon that illustrated in FIG. 7A by adding a second system 760 for dynamically updating the pre-distortion applied by the first system responsive to any residual distortion still present in the transmitted signal.

In this second system 760, a diplexer 744 is provided to allow directional signal flow from the transmitter to the antenna and from the antenna to the receiver in a frequency frequency division duplexing scheme, where the transmit and receive signal duplexes utilize different frequency bands. (Alternatively, separate antennas could be provided, one coupled to amplifier 726 for transmission, and one coupled to demodulator 746 for reception).

While in the receive mode of operation, antenna 728 receives the transmission from the remote relay station. The transmission is demodulated by demodulator 746 to recover the underlying symbols. The symbols are then compared by comparator 748 with the symbols not subject to pre-distortion which were previously stored in memory 742 by pre-distortion logic 712 while in polar form. The storage of these symbols in memory 742 is indicated in the figure with numeral 740.

The comparator 748 generates an error signal representing the difference between the received symbols and the symbols not subject to pre-distortion and transmitted by the remote relay station. This error signal has two components, the first, indicated in the figure with AE, representing the residual distortion remaining in the envelope of the symbols, and the second, indicated in the figure with Δθ, representing the residual distortion remaining in the phase of the symbols. These error signal components are each indexed by the desired (envelope) magnitude. Each component may be expressed in the form of an offset or a ratio. Moreover, when expressed as an offset, the component may be in absolute terms or in terms of dB.

This error signal is input to filter 750, which attenuates the error signal. This signal may then be averaged with other attenuated error signals indexed by the same (or similar) reference magnitude in successive time periods. This processing is performed for numerous different envelope reference indices, so that corrections at various locations over the full range of the envelope reference indices may be obtained. The attenuation and filtering action helps average additive noise introduced by the receiver, and also slows the adaptation reaction time, so that the pre-distortion system is stable, and does not excessively overshoot, or ring, as it initially pushes the table entries toward their convergent, optimal values. The resulting averaged values, Δ\overline{E} and Δ\overline{θ}, for a particular envelope reference index, are then used to update the lookup table entries corresponding to the particular reference index value E. In particular, a positive value of Δ\overline{E} indicates that the level of pre-distortion applied to the envelope value is insufficient, while a negative value indicates that too much pre-distortion is being applied to the envelope values. Conversely, a positive value of Δ\overline{θ} indicates that an excessive amount of pre-distortion was applied to θ, while a negative value of Δ\overline{θ} indicates that an insufficient amount of pre-distortion was applied to θ. Therefore, in one implementation, a small fraction of Δ\overline{E} is added to the lookup table entry E′ corresponding to the index E, and a small fraction of Δ\overline{θ} is subtracted from the lookup table entry Δθ′ corresponding to the index E. A small fraction of the error is used in both cases in order to avoid overshoot and ringing in the level of pre-distortion applied, which, because of the long delay in the feedback loop extending from the transmitter to the relay station and back to the transmitter, could last for long periods of time. What's more, interpolation between points as previously described may be used so that not every entry in the lookup table has to be updated directly from measurements evaluated at the index in question.

Referring to FIG. 7D, a fourth embodiment of a system for pre-distorting samples derived from modulation symbols to account for distortion introduced by a power-constrained remote relay station is illustrated. This embodiment is identical to the second embodiment illustrated in FIG. 7B in relation to the manner in which incoming symbols are pre-distorted, upconverted to RF frequencies, and then transmitted. However, the embodiment of FIG. 7D builds upon that illustrated in FIG. 7B by adding the second system 760 for dynamically updating the pre-distortion applied by the first system responsive to any residual distortion still present in the transmitted signal. This second system 760 is identical to that illustrated and described in relation to FIG. 7C. Therefore, further explanation of this second system is unnecessary in relation to FIG. 7D.

In the embodiments of FIGS. 7C and 7D, the memory 742 may be any memory accessible by the pre-distortion logic 712 or 730, including RAM, flip-flops, PROM, EPROM, EEPROM, disks, hard disk, floppy disk, CD-ROM, DVD, flash memory, etc. Moreover, in any of the foregoing embodiments, the pre-distortion logic, identified with numerals 712 or 730, may be embodied in the form of hardware, software, or a combination of hardware and software. For example, the pre-distortion logic may be synthesized combinatorial and arithmetic logic within an ASIC, or a DSP executing software. For purposes of this disclosure, the term “logic” refers to hardware, software, or a combination of hardware and software.

Also, in the embodiments of FIGS. 7C and 7D, the second system may combined or integrated with the first system to form a transceiver system, or the second system may be co-located with the first system. Moreover, in these embodiments, in lieu of a single antenna 728 and a diplexer 744 for implementing a frequency division diplexing scheme, it is possible to include two antennas in these embodiments, and avoid diplexer 744. One of the antennas would function as a transmission antenna and be coupled to the output of power amplifier 726, while the other antenna would function as a receive antenna and be coupled to the input of demodulator 746.

In addition, in any of the foregoing embodiments, it is possible to pre-distort samples derived from the symbols without converting the same to polar (E, θ) form. Instead, it is possible to pre-distort the samples while still in rectangular form (I, Q), for example, by adding gain to both I and Q, and phase rotating them jointly

It is also possible to pre-distort the samples in any of the foregoing embodiments algebraically, without the use of lookup tables. For example, equations embodying the pre-distortion characteristics 522 and 524 illustrated, respectively, in FIGS. 6A and 6B, may be used to pre-distort the samples. In the embodiments illustrated in FIGS. 7C and 7D, these equations may be updated responsive to any residual distortion detected in the feedback loop.

In the embodiments of FIGS. 7C and 7D, it is also possible to detect residual distortion using a predetermined training sequence of known symbols and/or samples in lieu of symbols/samples buffered in memory 742 “on the fly”. In this case, link 740 could be eliminated, and the predetermined sequence stored permanently in memory 742. This predetermined sequence would then be periodically transmitted to and received from the relay station in the manner previously described, and the received sequence compared with the known sequence to detect any residual distortion that may still be present.

Embodiments are also possible where the pre-distortion applied by pre-distortion logic 712, 730 accounts for distortion introduced in the entire feedback loop, not just through the non-linear operation of the power amplifier in the remote relay station. For example, this pre-distortion may also account for any distortion introduced by non-linear operation of the power amplifier 726 in the ground station (typically minor since the ground station is not generally power constrained as is the remote relay station), and/or transponding action of the remote relay station.

It is also possible, in any of the embodiments illustrated in FIGS. 7A-7D for the shaping filter 708 to follow the pre-distortion logic (identified with numeral 712 in FIGS. 7A and 7C, and identified with numeral 730 in FIGS. 7B and 7E), rather than precede it. In particular, samples derived from the modulation symbols may be pre-distorted by the pre-distortion logic, the pre-distorted samples filtered by the shaping filter, and samples derived from the filtered samples incorporated into the transmission signal.

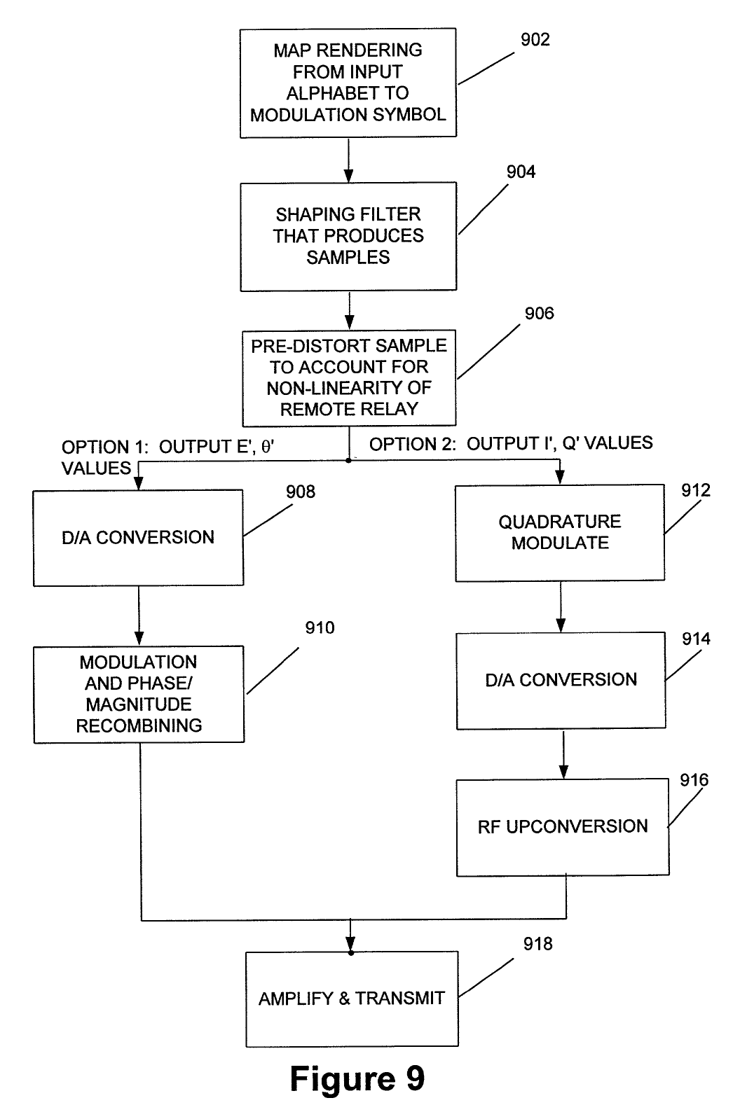

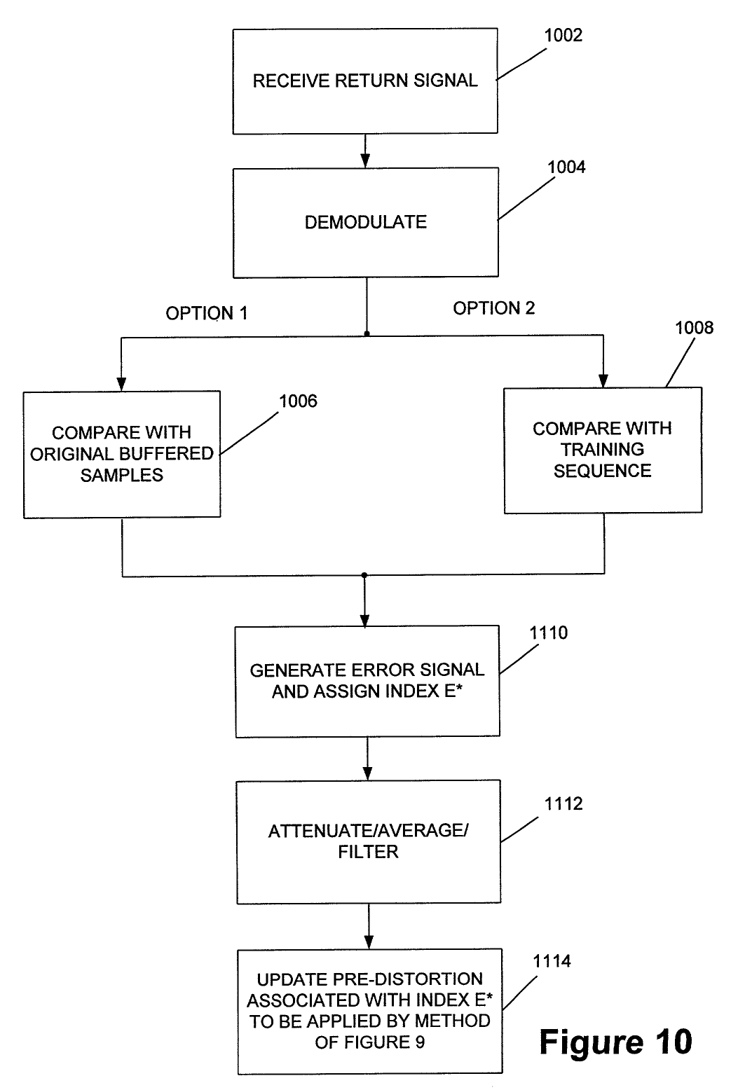

FIG. 9 is a flowchart of one embodiment of a method according to the invention of pre-distorting samples derived from modulation symbols to account for distortion introduced by a power-constrained remote relay station. As illustrated, in step 902, successive renderings of an input alphabet are mapped into successive modulation symbols, such as 16-QAM or 64-QAM symbols. Next, in step 904, the I and Q components of the symbols are passed through a shaping filter (such as filter 708 in FIGS. 7A-7D), to create samples of at least twice the symbol rate. In step 906, the samples are pre-distorted to compensate at least in part for non-linear operation of the remote (downstream) power amplifier. In one embodiment, a predetermined pre-distorted sample is substituted for each of the samples resulting from step 904. In one implementation, each pre-distorted sample reflects a modification of the amplitude and/or phase of the original sample to counteract, at least in part, for distortion introduced by non-linear operation of the power amplifier in the remote relay station, although, as discussed, it is also possible for this pre-distortion to account for other distortion introduced in the feedback loop. Moreover, it is possible to pre-distort the samples by either retaining the samples in quadrature form, or translating them into polar form first; it is also possible to pre-distort the samples algebraically or through some other means, such as accesses a lookup table, possibly followed by interpolation.

The pre-distorted samples may be in rectangular or polar form. If in polar form, option 1 in FIG. 9 is followed; if in rectangular form, option 2 in FIG. 9 is followed.

In the case in which option 1 is followed, in step 908, the pre-distorted samples are D/A converted, and then, in step 910, modulated onto a carrier using a technique which recombines the phase and envelope components—oftentimes at an RF frequency. Alternately, in the case that option 2 is followed, in step 912, they may be (digitally) quadrature modulated, then, in step 914, D/A converted. Following this, in step 916, they may be RF upconverted.

The resulting modulated signal from either steps 910 or 916 is then amplified and transmitted in step 918, a process which generally does not introduce distortion into the signal (although the invention will accommodate for this).

In the foregoing embodiment, it is possible for step 904 to occur after 906 such that samples derived from the modulation symbols are pre-distorted, the pre-distorted samples then filtered, and samples derived from the filtered samples then incorporated into the transmission signal.

FIG. 10 is a flowchart of one embodiment of a method according to the invention for updating the pre-distortion of samples derived from modulation symbols applied by the method of FIG. 9 to account for any residual distortion detected through a feedback loop from the ground station transmitter to the remote relay station and back again to the ground station transmitter.

In step 1002, a receiver co-located or integral with the ground station transmitter gathers the return signal, and then, in step 1004, demodulates the signal to recover samples of the linear modulation symbols. At this point, as illustrated, two options are possible. The first option, embodied in step 1006, is to compare the recovered samples with original samples that have been buffered. The second option, embodied in step 1008, is to compare the recovered samples with a designated training sequence which is known and need not be buffered in real time. (This allows the system operator to send periodic known training sequences that exercise the full input range of the pre-distortion table.) Step 1110 is then performed. In step 1110, the recovered samples are compared with the original or designated samples (not subject to pre-distortion) to compute an error signal (which would generally be in terms of E and 0). These error samples are then assigned an index E* associated with the desired envelope response. Step 1112 follows step 1100. In step 1112, the error signal is attenuated/filtered and/or averaged in order to eliminate additive noise that may have been introduced, but also to avoid excessive or prolonged ringing or overshoot in the convergence of the pre-distortion values which could otherwise occur.

Step 1114 is then performed. In step 1114, the pre-distortion at an index E* applied by the method of FIG. 9 is updated responsive to the averaged error signal generated in step 1112. Note that, in the case in which the method of FIG. 9 pre-distorts samples using a pre-distortion lookup table in which pre-distorted entries E′ and Δθ′ are maintained indexed by values of E, the values of E, as well as the filtered error values Δ\overline{E} and Δ\overline{θ}, must typically be provided to the control loops for updating of the table entires. In particular, the control loop uses the desired envelope E as an index, and also requires the average envelope offset Δ\overline{E}, and the phase offset Δ\overline{θ}. For the desired envelope value E, if the error signal indicates that a larger envelope value is needed to obtain that desired envelope value, the control loop will multiply the magnitude of the average error signal Δ\overline{E} by a very small value, so that the envelope is slightly increased (at that input envelope value in the table) in subsequent transmissions. The same procedure is used for the phase offset, where, for a desired envelope value E*, if the average error signal Δ\overline{θ} indicates that a larger phase offset value is needed to obtain a desired phase offset, it will multiply the magnitude of the average phase offset Δ\overline{θ} by a very small value, so that the phase offset is slightly increased (at that input envelope value in the table) in subsequent transmissions. Note that this updating should be incremental or conservative to avoid prolonged ringing or overshoot which could occur because the delay over the feedback loop from the remote relay station is typically very long. Any of the foregoing methods may be tangibly embodied in the form of hardware, software, or a combination of hardware and software. In one implementation, any of these methods may be tangibly embodied as a series of instructions stored on a processor readable medium including but not limited to flip-flops, synthesized logic, RAM, ROM, PROM, EPROM, EEPROM, disk, hard disk, floppy disk, CD-ROM, DVD, flash memory, etc.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A system for pre-distorting samples derived from modulation symbols to compensate for distortion introduced by a remote relay station comprising:
a mapper for mapping successive renderings of an input alphabet into successive modulation symbols;
pre-distortion logic for pre-distorting samples derived from the modulation symbols to compensate, at least in part, for distortion introduced by the remote relay station;
logic for incorporating samples derived from the pre-distorted samples into a transmission signal; and
logic for amplifying and transmitting the transmission signal over a communications link to the remote relay station.

2. The system of claim 1 wherein the pre-distortion logic algebraically pre-distorts the samples.

3. The system of claim 1 wherein the pre-distortion logic pre-distorts the samples by substituting pre-distorted samples derived from values obtained from a lookup table.

4. The system of claim 1 wherein the pre-distorted samples are expressed in quadrature form.

5. The system of claim 1 wherein the pre-distorted samples are expressed in polar form.

6. The system of claim 1 wherein the modulation symbols are M-QAM symbols.

7. The system of claim 1 wherein the modulation symbols are linear modulation symbols.

8. The system of claim 1 wherein the modulation symbols are amplitude-only modulated symbols.

9. The system of claim 1 where the modulation symbols are M-PSK or other phase-modulated symbols.

10. A transmitter including the system of claim 1.

11. A transceiver including the system of claim 1.

12. The system of claim 1 wherein the communications link is a wireless link.

13. The system of claim 1 wherein the communications link is a wireline link.

14. The system of claim 1 wherein the remote relay station is a satellite.

15. The system of claim 1 further comprising a second system, the second system comprising:
a receiver for receiving a signal relayed by the remote relay station and derived from the transmission signal;
logic for recovering samples of modulation symbols from the relayed signal;
logic for comparing the recovered samples with corresponding samples not subject to pre-distortion to generate an error signal; and
logic for updating the pre-distortion applied by the pre-distortion logic responsive to the error signal.

16. A system for pre-distorting samples derived from modulation symbols to compensate for distortion introduced by a remote relay station comprising:
mapping means for mapping successive renderings of an input alphabet into successive modulation symbols;
pre-distortion means for pre-distorting samples derived from the modulation symbols to compensate for distortion introduced by the remote relay station;
means for incorporating samples derived from the pre-distorted samples into a transmission signal; and
means for amplifying and transmitting the transmission signal over a communications link to the remote relay station.

17. The system of claim 16 further comprising a second system, the second system comprising:
receiver means for receiving a signal relayed by the remote relay station and derived from the transmission signal;
means for recovering samples of modulation symbols from the relayed signal;
means for comparing the recovered samples with corresponding samples not subject to pre-distortion to generate an error signal; and
means for updating the pre-distortion applied by the pre-distortion logic responsive to the error signal.

18. The system of claim 17 wherein the error signal comprises a magnitude offset.

19. The system of claim 18 wherein the error signal can be expressed as mr−md, where mr is the received magnitude and md is the desired magnitude.

20. The system of claim 17 wherein the error signal comprises a magnitude ratio.

21. The system of claim 20 wherein the error signal can be expressed as mr/md, where mr is the received magnitude and md is the desired magnitude.

22. The system of claim 20 wherein the error signal can be expressed as mr_dB−md_dB, where mr is the received magnitude in dB and md is the desired magnitude in dB.

23. The system of claim 17 wherein the error signal comprises a phase offset.

24. The system of claim 23 wherein the error signal can be expressed as θ_{d}−θᵣ, where θ_{d} is the desired phase and θᵣ is the received phase.

25. The system of claim 17 wherein the error signal comprises a magnitude offset or ratio and a phase offset.

26. A method for pre-distorting samples derived from modulation symbols to compensate for distortion introduced by a remote relay station comprising:
mapping successive renderings of an input alphabet into successive modulation symbols;
pre-distorting samples derived from the modulation symbols to compensate, at least in part, for distortion introduced by the remote relay station;
incorporating samples derived from the pre-distorted samples into a transmission signal; and
amplifying and transmitting the transmission signal to the remote relay station over a communications link.

27. The method of claim 26 further comprising algebraically pre-distorting the samples.

28. The method of claim 26 further comprising pre-distorting the samples by accessing one or more entries from a lookup table.

29. The method of claim 28 further comprising interpolating between entries from the lookup table.

30. The method of claim 26 further comprising:
receiving a signal relayed by the remote relay station and derived from the transmission signal;
recovering samples of modulation symbols from the relayed signal;
comparing the recovered samples with corresponding samples not subject to pre-distortion to generate an error signal; and
updating the pre-distortion applied by the pre-distortion logic responsive to the error signal.

31. The method of claim 30 wherein the updating step comprises updating entries in a lookup table.

32. The method of claim 31 wherein the updating step comprises updating those entries in a lookup table which may be input to an interpolation operation.

33. A method for pre-distorting samples derived from modulation symbols to compensate for distortion introduced by a remote relay station comprising:
a step for mapping successive renderings of an input alphabet into successive modulation symbols;
a step for pre-distorting samples derived from the modulation symbols to compensate, at least in part, for distortion introduced by the remote relay station;
a step for incorporating samples derived from the pre-distorted samples into a transmission signal; and
a step for amplifying and transmitting the transmission signal to the remote relay station over a communications link.

34. The method of claim 33 further comprising:
a step for receiving a signal relayed by the remote relay station and derived from the transmission signal;
a step for recovering samples of modulation symbols from the relayed signal;
a step for comparing the recovered samples with corresponding samples not subject to pre-distortion to generate an error signal; and
a step for updating the pre-distortion applied by the pre-distortion logic responsive to the error signal.

35. The method of claim 34 wherein the step for updating comprises updating entries in a lookup table.

36. The method of claim 35 wherein the step for updating comprises updating those entries in the lookup table which may be inputs to an interpolation operation.

37. The system of claim 1 further comprising a shaping filter for filtering successive modulation symbols to obtain the samples that are pre-distorted by the pre-distortion logic.

38. The system of claim 1 further comprising a shaping filter for filtering the pre-distorted samples from the pre-distortion logic to obtain the samples which are incorporated into the transmission signal.

39. The system of claim 16 further comprising shaping filter means for filtering successive modulation symbols to obtain the samples that are pre-distorted by the pre-distortion logic.

40. The system of claim 16 further comprising shaping filter means for filtering the pre-distorted samples from the pre-distortion means to obtain the samples which are incorporated into the transmission signal.
